(19) United States
(12) Patent Application Publication
(10) Pub. No.: US 2014/0354180 A1
(43) Pub. Date: Dec. 4, 2014

(54) BACKLIGHT DRIVING CIRCUIT, LCD DEVICE, AND METHOD FOR DRIVING THE BACKLIGHT DRIVING CIRCUIT

(71) Applicant: SHENZHEN CHINA STAR OPTOELECTRONICS TECHNOLOGY CO., LTD., Shenzhen (CN)

(72) Inventors: Hua Zhang, Shenzhen (CN); Fei Li, Shenzhen (CN)

(73) Assignee: SHENZHEN CHINA STAR OPTOELECTRONICS TECHNOLOGY CO., LTD, Shenzhen (CN)

(21) Appl. No.: 13/984,530

(22) PCT Filed: Jun. 27, 2013
(86) PCT No.: PCT/CN2013/078162

§ 371 Date: Aug. 8, 2013

(30) Foreign Application Priority Data
May 28, 2013 (CN) 201310203882.7

(51) Int. Cl. G09G 3/34; H05B 33/08

(52) U.S. Cl. CPC G09G 3/3406; H05B 33/0845
USPC 315/307

(57) ABSTRACT

A backlight driving circuit includes a light emitting diode (LED) lightbar, a power supply driving the LED lightbar, a constant current driving chip controlling the power supply and the LED lightbar, and a control unit monitoring a voltage of a cathode of the LED lightbar. The constant current driving chip includes a main control unit that drives the power supply, and an adjusting unit that adjusts brightness of the LED lightbar. An input end of the adjusting unit is coupled to the cathode of the LED lightbar, and an output end of the adjusting unit is coupled to a load unit, a resistance value of the load unit may be adjusted. When the voltage of the cathode of the LED lightbar is greater than or equal to a preset threshold, the control unit controls the load unit to reduce the resistance value of the load unit.

### TECHNICAL FIELD

The present disclosure relates to the field of liquid crystal displays (LCDs), and more particularly to a backlight driving circuit, an LCD device, and a method for driving the backlight driving circuit.

### BACKGROUND

A liquid crystal display (LCD) device includes an LCD panel and a backlight unit. A typical backlight unit uses a light emitting diode (LED) lightbar as light source and uses an LED backlight driving circuit to drive the LED lightbar to display. As shown in FIG. 1, the typical LED backlight driving circuit includes an LED lightbar 20, a power supply 10 driving the LED lightbar 20 to display, and a constant current driving chip 30 controlling the power supply 10 and the LED lightbar 20. The constant current driving chip 30 includes an adjusting unit 32 that adjusts brightness of the LED lightbar 20. An input end of the adjusting unit 32 is connected with a cathode of the LED lightbar, and an output end of the adjusting unit 32 is coupled to a ground terminal of the LED backlight driving circuit through a resistor.

When any one of LED lamps of the LED lightbar 20 short-circuits, temperature of the constant current driving chip 30 increases, thus the affecting stability of an entire LED backlight driving circuit.

### SUMMARY

The aim of the present disclosure is to provide a backlight driving circuit, a liquid crystal display (LCD) device, and a method for driving the backlight driving circuit capable of reducing power loss of a constant current driving chip and improving stability of an entire backlight driving circuit after any one of LED lamps of the LED lightbar short-circuits.

The aim of the present disclosure is achieved by the following method.

A backlight driving circuit comprises a light emitting diode (LED) lightbar, a power supply driving the LED lightbar, a constant current driving chip controlling the power supply and the LED lightbar, and a control unit monitoring a voltage of a cathode of the LED lightbar. The constant current driving chip comprises a main control unit that drives the power supply, and an adjusting unit that adjusts brightness of the LED lightbar. An input end of the adjusting unit is coupled to the cathode of the LED lightbar, and an output end of the adjusting unit is coupled to a load unit, a resistance value of the load unit is adjusted.

When the voltage of the cathode of the LED lightbar is greater than or equal to a preset threshold, the control unit controls the load unit to reduce the resistance value of the load unit.

Furthermore, the load unit comprises N resistors connected in parallel, and (N−1) resistors are connected with the controllable switches in series; when the voltage of the cathode of the LED lightbars is greater than or equal to the preset threshold, the control unit controls at least one controllable switch to turn on. N is a natural number that is greater than or equal to 2. This is specific circuit of the load unit using a plurality of resistors connected in parallel, and each of the resistors is controlled by the controllable switch. As a number of the controllable switch being on increases, the resistance value of the load unit reduces. Thus, when the voltage of the cathode of the LED lightbar is greater than or equal to the preset threshold, the control unit controls at least one controllable switch to turn on, which reduces the resistance value of the load unit.

Furthermore, the load unit comprises a first resistor and a second resistor that are connected in parallel. The second resistor is connected with a first controllable switch in series. When the voltage of the cathode of the LED lightbar is greater than or equal to the preset threshold, the control unit controls the first controllable switch to turn on. This is a method of using two connected-in-parallel resistors, where only one controllable switch needs to be controlled, and the control method is easy, development difficulty and hardware cost are reduced.

Furthermore, the control unit comprises a first comparator and a monitor unit. A first reference voltage is input to a first input end of the first comparator, a second input end of the first is coupled to the monitor unit. When the voltage of the cathode of the LED lightbar is greater than or equal to the first reference voltage, the first comparator outputs a reserved voltage, and the monitor unit controls the load unit to reduce the resistance value of the load unit. The first reference voltage is less than or equal to the preset threshold. The first comparator quickly determines whether the voltage of the cathode of the LED lightbar exceeds the preset threshold. When the voltage of the cathode of the LED lightbar exceeds the preset threshold, the first comparator outputs the reserved voltage, namely the first comparator outputs a low level signal at first, when the voltage of the cathode of the LED lightbar exceeds the preset threshold, the first comparator outputs a high level signal. Thus, according to change of the output voltage of the first comparator, the monitor unit may determine whether the LED lamp is short-circuited, and further controls the load unit to reduce the resistance value of the load unit.

Furthermore, the monitor unit comprises an adjusting assembly that adjusts a duty cycle of a pulse-width modulation (PWM) dimming signal. The adjusting assembly is coupled to the adjusting unit. When the voltage of the cathode of the LED lightbars is greater than or equal to the preset threshold, the adjusting assembly reduces the duty cycle of the PWM dimming signal. When the resistance value of the load unit reduces, current flowing through the LED lightbar increases, and brightness of the LED lightbar increases. In order to make brightness of the LED lightbar that is short-circuited be consistent with brightness of the LED lightbars that are not short-circuited, the adjusting assembly of the monitor unit outputs a PWM dimming signal having a small duty cycle to the adjusting unit of the constant current driving chip, which allows current of the LED lightbar that is short-circuited to be consistent with current of the LED lightbars that are not short-circuited.

Furthermore, the adjusting unit comprises a second controllable switch and a second comparator coupled to the second controllable switch. The second controllable switch is connected in series between the cathode of the LED lightbar and the load unit. An output end of the adjusting assembly is coupled to a control end of the second controllable switch. This is a specific circuit of the adjusting unit using the second controllable switch to control effective current of the LED lightbar.

Furthermore, the load unit comprises a first resistor and a second resistor that are connected in parallel, where the second resistor is connected with a first controllable switch in series.

The control unit comprises a first comparator and a monitor unit. A first reference voltage is input to a first input end of the first comparator, a second input end of the first comparator is coupled to the cathode of the LED lightbar, and an output end of the first comparator is coupled to the monitor unit. The first reference voltage is less than or equal to the preset threshold.

The monitor unit comprises an adjusting assembly that adjusts a duty cycle of a pulse-width modulation (PWM) dimming signal. The adjusting assembly is coupled to the adjusting unit. The adjusting unit comprises a second controllable switch and a second comparator coupled to the second controllable switch. The second controllable switch is connected in series between the cathode of the LED lightbar and the load unit. An output end of the adjusting assembly is coupled to a control end of the second controllable switch.

When the voltage of the cathode of the LED lightbars is greater than or equal to the first reference voltage, the first comparator outputs a reserved voltage, and the control unit controls the first controllable switch to turn on, and simultaneously, the adjusting assembly reduces the duty cycle of the PWM dimming signal.

The load unit uses two connected-in-parallel resistors, first controllable switch is used to control the second resistor. When the voltage of the cathode of the LED lightbar is greater than or equal to the preset threshold, the control unit controls the first controllable switch to turn on, and current flows through the second resistor. Thus, the resistance value of the load unit is equal to the resistance value of two connected-in-parallel resistors, which is less than the first resistor (the first resistor is equal to the resistance value of the load unit when the first controllable switch turns off). The present disclosure uses a method of using two connected-in-parallel resistors, and only needs to control one controllable switch, thus the control method is easy, development difficulty and hardware cost are reduced. The first comparator quickly determines whether the voltage of the cathode of the LED lightbar exceeds the preset threshold. When the voltage of the cathode of the LED lightbar exceeds the preset threshold, the first comparator outputs the reserved voltage, namely the first comparator outputs a low level signal at first, when the voltage of the cathode of the LED lightbar exceeds the preset threshold, the first comparator outputs a high level signal. Thus, according to change of the output voltage of the first comparator, the monitor unit may determine whether the LED lamp is short-circuited, and further controls the load unit to reduce the resistance value of the load unit.

When the resistance value of the load unit reduces, current flowing through the LED lightbar increases and brightness of the LED lightbar increases. In order to make brightness of the LED lightbar that is short-circuited to be consistent with brightness of the LED lightbars that are not short-circuited, the adjusting assembly of the monitor unit outputs a PWM dimming signal having a small duty cycle to the adjusting unit of the constant current driving chip, which allows current flowing through the LED lightbar that is short-circuited to be consistent with current of the LED lightbars that are not short-circuited.

A light crystal display (LCD) device comprises a backlight driving circuit of the present disclosure.

A method for driving a backlight driving circuit. The backlight driving circuit comprises an LED lightbar, a power supply driving the LED lightbar, and a constant current driving chip controlling the power supply and the LED lightbar. The constant current driving chip comprises a main control unit that drives the power supply, and an adjusting unit that adjusts brightness of the LED lightbar, an input end of the adjusting unit is coupled to a cathode of the LED lightbar, and an output end of the adjusting unit is coupled to a load unit, a resistance value of the load unit is adjusted. The method comprises:

A: setting a preset threshold; and

B: monitoring a voltage of the cathode of the LED lightbar, if the voltage of the cathode of the LED lightbar is greater than or equal to the preset threshold, reducing the resistance value of the load unit. If the voltage of the cathode of the LED lightbar is less than the preset threshold, maintaining the resistance value of the load unit.

Furthermore, the step B comprises: when reducing the resistance value of the load unit, reducing a duty cycle of a driving signal of the adjusting unit, which allows effective current flowing through the LED lightbar that is short-circuited to be consistent with current flowing through the LED lightbars that are not short-circuited. When the resistance value of the load unit reduces, current flowing through the LED lightbar increases, and brightness of the LED lightbar increases. In order to make brightness of the LED lightbar that is short-circuited be consistent with brightness of the LED lightbars that are not short-circuited, the adjusting assembly of the monitor unit outputs a PWM dimming signal having a small duty cycle to the adjusting unit of the constant current driving chip, which allows current of the LED lightbar that is short-circuited to be consistent with current of the LED lightbars that are not short-circuited.

It should be understood that current is determined by a reference voltage V input to the adjusting unit and a resistance value R of a resistor connected in series between the adjusting unit and the ground terminal of the backlight driving circuit. An equation of current flowing through the LED lightbar is: I=V1/R (V1 is the voltage of the cathode of the LED lightbar). The adjusting unit controls the duty cycle of the current of the LED lightbar to adjust backlight brightness of the LED lightbar. A voltage Vo outputted by the power supply is relative to the current flowing through the LED lightbar, when the current flowing through the LED lightbar is great, the voltage Vo driving the LED lightbars is corresponding great. An equation of the voltage Vo is: Vo=Vin/(1−D), where Vin is an input voltage of the power supply, and D is a duty cycle of the power supply.

When any one LED lamps of the LED lightbar short-circuits, a redundant voltage of the cathode of the LED lightbar (about 6 V) is input to the adjusting unit, which results in increasing temperature of the constant current driving chip, thereby affecting stability of an entire backlight driving circuit. The present disclosure uses the control unit and the load unit, when one or more LED lamps of the LED lightbar short-circuit, the voltage of the cathode of the LED lightbar increases. Thus, the voltage of the cathode of the LED lightbar is regarded as the preset threshold when one or more LED lamps of the LED lightbar short-circuit. When the control unit monitors that the voltage of the cathode of the LED lightbar is greater than or equal to the preset threshold, the control unit controls the load unit to reduce the resistance value of the load unit. According to the equation of I=V1/R, as the resistance value of the load unit reduces, the current flowing through the LED lightbar increases, the redundant voltage is uniformly assigned to remaining LED lamps that are not short-circuited, and the voltage of the cathode of the LED lightbar reduces, thus correspondingly reducing voltage of the adjusting unit and temperature of the constant current driving chip. Therefore, the present disclosure reduces power loss of the constant current driving chip and improves stability of the entire backlight driving circuit when the LED lamps short-circuits.

### BRIEF DESCRIPTION OF FIGURES

FIG. 1 is a schematic diagram of a typical backlight driving circuit;

FIG. 2 is a schematic diagram of a backlight driving circuit of a first example of the present disclosure;

FIG. 3 is a schematic diagram of a backlight driving circuit of a second example of the present disclosure; and

FIG. 4 is a flowchart of a method for driving a backlight driving circuit of a third example of the present disclosure.

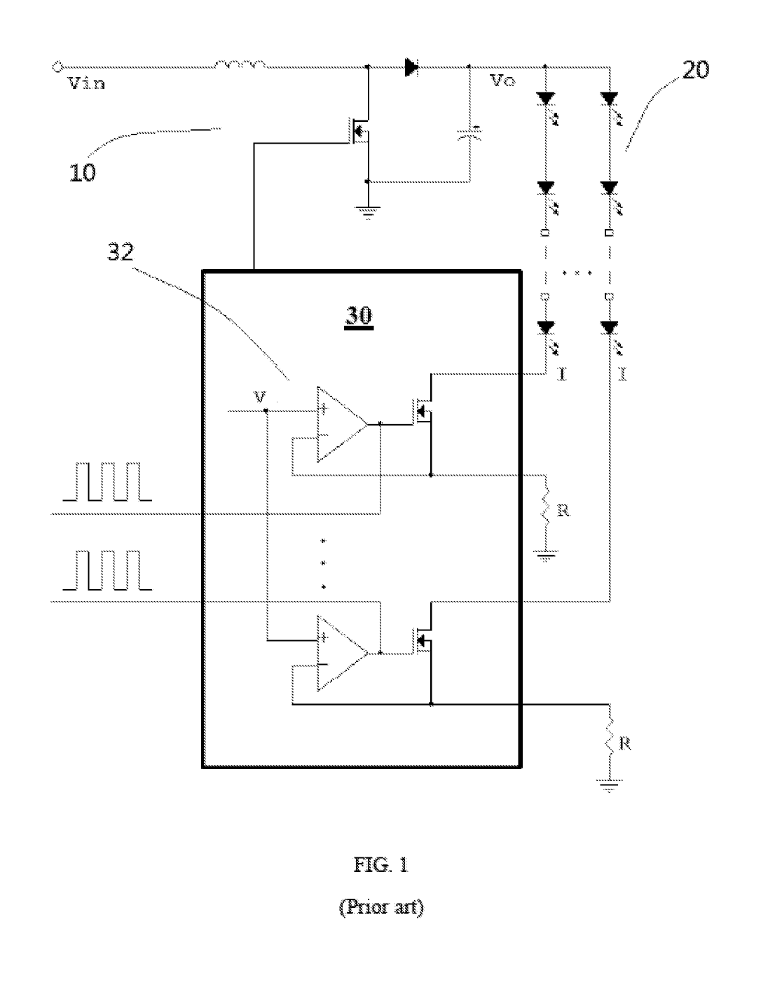

### DETAILED DESCRIPTION

The present disclosure provides a liquid crystal display (LCD) device comprising an LCD panel and a backlight unit. The backlight unit comprises a backlight driving circuit. The backlight driving circuit comprises a light emitting diode (LED) lightbar, a power supply driving the LED lightbar to display, and a constant current driving chip controlling the power supply and the LED lightbar. The constant current driving chip comprises a main control unit that drives the power supply, and an adjusting unit that adjusts brightness of the LED lightbar. An input end of the adjusting unit is coupled to a cathode of the LED lightbar, and an output end of the adjusting unit is coupled to a load unit, where a resistance value of the load unit can be adjusted. The backlight driving circuit further comprises a control unit that monitors voltage of the cathode of the LED lightbar.

When the voltage of the cathode of the LED lightbar is greater than or equal to a preset threshold, the control unit controls the load unit to reduce a resistance value of the load unit.

It should be understood that current is determined by a reference voltage V input to the adjusting unit and a resistance value R of a resistor connected in series between the adjusting unit and a ground terminal of the backlight driving circuit. An equation of current flowing through the LED lightbar is: I=V1/R (V1 is the voltage of the cathode of the LED lightbar). The adjusting unit adjusts backlight brightness of the LED lightbar by controlling a duty cycle of the current flowing through the LED lightbar. A voltage Vo outputted by the power supply is relative to the current flowing through the LED lightbar, when the current flowing through the LED lightbar is great, the voltage Vo driving the LED lightbars is corresponding great. An equation of the voltage Vo is: Vo=Vin/(1−D), where Vin is an input voltage of the power supply, and D is a duty cycle of the power supply.

When any one of LED lamps of the LED lightbar short-circuits, a redundant voltage of the cathode of the LED lightbar (about 6 V) is input to the adjusting unit, which results in increasing temperature of the constant current driving chip, thereby affecting stability of an entire backlight driving circuit. The present disclosure uses the control unit and the load unit, when one or more LED lamps of the LED lightbar short-circuit, the voltage of the cathode of the LED lightbar increases. Thus, the voltage of the cathode of the LED lightbar is regarded as a preset threshold when one or more LED lamps of the LED lightbar short-circuit. When the control unit monitors that the voltage of the cathode of the LED lightbar is greater than or equal to the preset threshold, the control unit controls the load unit to reduce the resistance value of the load unit. According to the equation of I=V1/R, as the resistance value of the load unit reduces, the current flowing through the LED lightbar increases, the redundant voltage is uniformly assigned to remaining LED lamps that are not short-circuited, and the voltage of the cathode of the LED lightbar reduces, thus correspondingly reducing voltage of the adjusting unit and temperature of the constant current driving chip. Therefore, the present disclosure reduces power loss of the constant current driving chip and improves stability of the entire backlight driving circuit when the LED lamps short-circuits.

The present disclosure is further described in detail in accordance with the figures and the exemplary examples.

### EXAMPLE 1

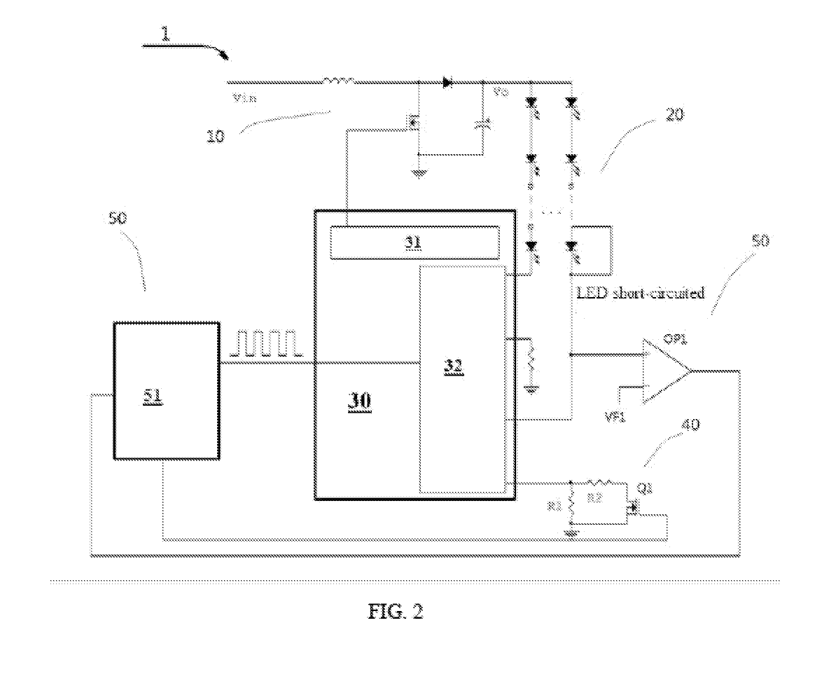

As shown in FIG. 2, a backlight driving circuit 1 of a first example comprises a light emitting diode (LED) lightbar 20, a power supply 10 driving the LED lightbar 20, and a constant current driving chip 30 controlling the power supply 10 and the LED lightbar 20. The constant current driving chip 30 comprises a main control unit 31 that drives the power supply, and an adjusting unit 32 that adjusts brightness of the LED lightbars 20. An input end of the adjusting unit 32 is coupled to a cathode of the LED lightbar 20, and an output end of the adjusting unit 32 is coupled to a load unit 40, a resistance value of the load unit 40 can be adjusted. The backlight driving circuit 1 further comprises a control unit 50 that monitors a voltage of the cathode of the LED lightbar. A plurality of the LED lightbars 20 are shown in FIG. 2. When the plurality of the LED lightbars 20 are arranged in the backlight driving circuit, a plurality of load units 40 and a plurality of control units 50 are correspondingly arranged in the backlight driving circuit and are used to control the plurality of LED lightbars 20; the first example only takes one LED lightbar, the load unit 40, and the control unit 50 for example to further describe the present disclosure, where the load unit 40 and the control unit 50 correspond to the one LED lightbar. It should be understood that each of the LED lightbars 20 corresponds to one load unit 40 and one control unit 50, structures of all units are same, and structures of all control units are same.

The load unit 40 comprises a first resistor R1 and a second resistor R2 that are connected in parallel. The second resistor R2 is connected with a first controllable switch Q1 in series. The control unit 50 comprises a first comparator OP1 and a monitor unit 51. The monitor unit 51 uses a microcontroller (MCU) or other control chips. A first reference voltage VF1 is input to a first input end of the first comparator OP1, a second input end of the first comparator OP1 is coupled to the cathode of the LED lightbar 20, and an output end of the first comparator OP1 is coupled to the monitor unit 51. When the voltage of the cathode of the LED lightbar 20 is greater than or equal to the first reference voltage VF1, the first comparator OP1 outputs a reserved voltage, the monitor unit 51 controls the first controllable switch Q1 to turn on. The first reference voltage VF1 is less than or equal to the preset threshold, the first reference voltage VF1 uses common voltage in the backlight driving circuit, such as 5V, 12V, and the like.

The load unit 40 uses two connected-in-parallel resistors, and the first controllable switch Q1 is used to control the second resistor R2. When the voltage of the cathode of the LED lightbar 20 is greater than or equal to the preset threshold (the first reference voltage VF1), the monitor unit 51 of the control unit 50 controls the first controllable switch Q1 to turn on, and current flows through the second resistor R2. Thus, the resistance value of the load unit 40 is equal to the resistance value of two connected-in-parallel resistors, which is less than the first resistor R1 (R1 is is equal to the resistance value Q1 of the load unit 40 when the first controllable switch turns off).

The first comparator OP1 quickly determines whether the voltage of the cathode of the LED lightbar exceeds the preset threshold. When the voltage of the cathode of the LED lightbar exceeds the preset threshold, the first comparator OP1 outputs the reserved voltage, namely the first comparator OP1 outputs a low level signal (logic 0) at first, when the voltage of the cathode of the LED lightbar exceeds the preset threshold, the first comparator OP1 outputs a high level signal (logic 1). Thus, according to change of the output voltage of the first comparator OP1, the monitor unit 51 may determine whether the LED lamp is short-circuited, and further controls the load unit to reduce the resistance value of the load unit.

The present disclosure uses a method of using two connected-in-parallel resistors, and only one controllable switch needs to be controlled, thus, the control method is easy, development difficulty and hardware cost are reduced. The present disclosure should not be limited to use two connected-in-parallel resistors and may further use a plurality of resistors connected in parallel. Namely the load unit 40 comprises N resistors connected in parallel, where (N−1) resistors are connected with the controllable switches in series, when the voltage of the cathode of the LED lightbar exceeds the preset threshold, as long as at least one controllable switch turns on, the resistance value of the load unit can be reduced. Thus, as a number of the controllable switch being on increases, the resistance value of the load unit reduces, where N is a natural number that is greater than or equal to 2.

### EXAMPLE 2

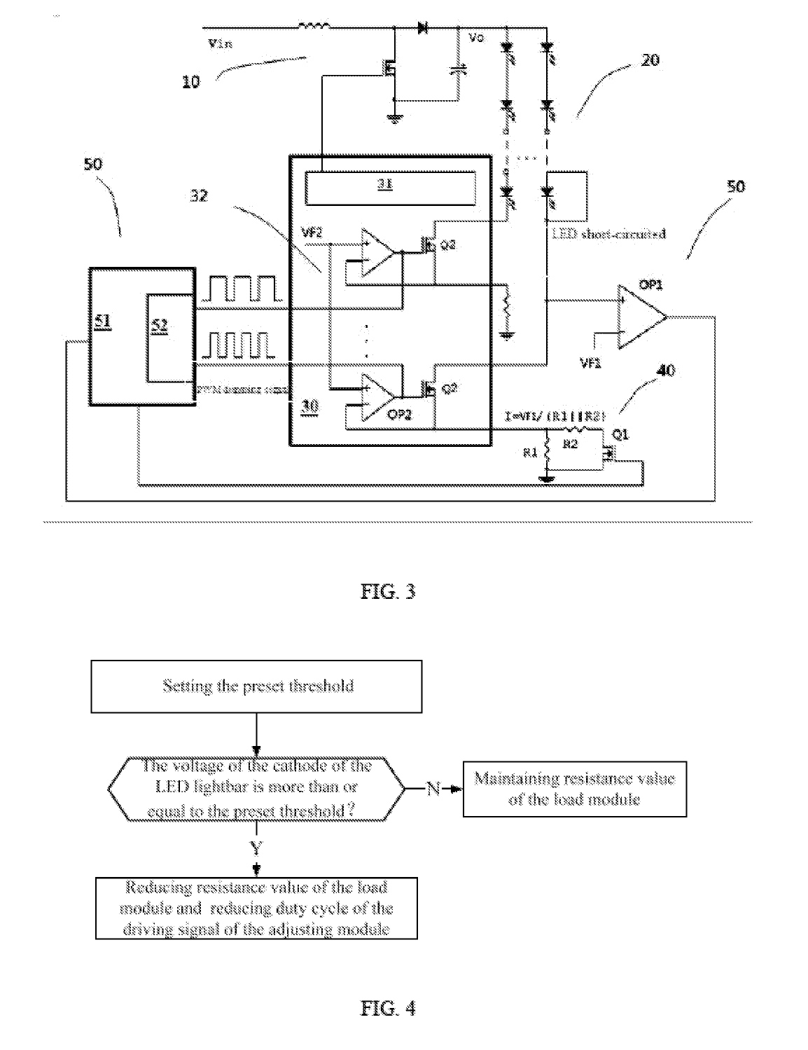

As shown in FIG. 3, a backlight driving circuit 1 of a second example comprises an LED lightbar 20, a power supply 10 driving the LED lightbar 20, and a constant current driving chip 30 controlling the power supply 10 and the LED lightbar 20. The constant current driving chip 30 comprises a main control unit 31 that drives the power supply, and an adjusting unit 32 that adjusts brightness of the LED lightbars 20. An input end of the adjusting unit 32 is coupled to a cathode of the LED lightbar 20, and an output end of the adjusting unit 32 is coupled to a load unit 40, where a resistance value of the load unit 40 can be adjusted. The backlight driving circuit 1 further comprises a control unit 50 that monitors a voltage of the cathode of the LED lightbar. A plurality of the LED lightbars 20 are shown in FIG. 3. When the plurality of the LED lightbars 20 are arranged in the backlight driving circuit, a plurality of load units 40 and a plurality of control units 50 are correspondingly arranged in the backlight driving circuit and are used to control the plurality of LED lightbars 20. The second example only takes one LED lightbar, the load unit 40, and the control unit 50 for example to further describe the present disclosure, where the load unit 40 and the control unit 50 correspond to the one LED lightbar. It should be understood that each of the LED lightbars 20 corresponds to one load unit 40 and one control unit

The load unit 40 comprises a first resistor R1 and a second resistor R2 that are connected in parallel. The second resistor R2 is connected with a first controllable switch Q1 in series.

The control unit 50 comprises a first comparator OP1 and a monitor unit 51. The monitor unit 51 uses a microcontroller (MCU) or other control chips. A first reference voltage VF1 is input to a first input end of the first comparator OP1, a second input end of the first comparator OP1 is coupled to the cathode of the LED lightbar 20, and an output end of the first comparator OP1 is coupled to the monitor unit 51. The first reference voltage VF1 is less than or equal to the preset threshold, the first reference voltage VF1 uses common voltage in the backlight driving circuit, such as 5V, 12V, and the like.

The monitor unit 51 comprises an adjusting assembly 52 which adjusts a duty cycle of a pulse-width modulation (PWM) dimming signal. The adjusting assembly 52 is coupled to the adjusting unit 32. The adjusting unit 32 comprises a second controllable switch Q2 and a second comparator OP2 coupled to the second controllable switch Q2. A second reference voltage V2 is input to a non-inverting input end of the second comparator OP2, and an inverting in put end of the second comparator OP2 is coupled to an output end of the second controllable switch Q2.

The second controllable switch Q2 is connected in series between the cathode of the LED lightbar 20 and the load unit 40. An output end of the adjusting assembly 52 is coupled to a control end of the second controllable switch Q2.

When the voltage of the cathode of the LED lightbar 20 is greater than or equal to the first reference voltage VF1, the first comparator OP1 outputs a reserved voltage. The monitor unit 51 controls the first controllable switch Q1 to turn on, in the meantime, the adjusting assembly 52 reduces the duty cycle of PWM dimming signal outputted by the adjusting assembly, which allows effective current flowing through the LED lightbar 20 that is short-circuited to be consistent with current flowing through the LED lightbars that are not short-circuited.

The load unit 40 uses two connected-in-parallel resistors, and the first controllable switch Q1 is used to control the second resistor R2. When the voltage of the cathode of the LED lightbar 20 is greater than or equal to the preset threshold, the control unit 50 controls the first controllable switch Q1 to turn on, and current flows through the second resistor R2. Thus, the resistance value of the load unit 40 is equal to the resistance value of two connected-in-parallel resistors, which is less than the first resistor R1 (R1 is equal to the resistance value of the load unit 40 when the first controllable switch Q1 turns off). The present disclosure uses a method of using two connected-in-parallel resistors, and only needs to control one controllable switch, thus the control method is easy, development difficulty and hardware cost are reduced.

The first comparator OP1 quickly determines whether the voltage of the cathode of the LED lightbar exceeds the preset threshold. When the voltage of the cathode of the LED lightbar exceeds the preset threshold, the first comparator OP1 outputs the reserved voltage, namely the first comparator OP1 outputs a low level signal (logic 0) at first, when the voltage of the cathode of the LED lightbar exceeds the preset threshold, the first comparator OP1 outputs a high level signal (logic 1). Thus, according to change of the output voltage of the first comparator OP1, the monitor unit 51 may determine whether the LED lamp is short-circuited, and further controls the load unit to reduce the resistance value of the load unit.

When the resistance value of the load unit reduces, current flowing through the LED lightbar increases, the brightness of the LED lightbar increases. In order to make brightness of the LED lightbar 20 that is short-circuited be consistent with brightness of the LED lightbars that are not short-circuited, the adjusting assembly 52 of the monitor unit 51 outputs a PWM dimming signal having a small duty cycle to the adjusting unit 32 of the constant current driving chip 30, which allows current flowing through the LED lightbar 20 that is short-circuited to be consistent with current flowing through the LED lightbars that are not short-circuited.

The present disclosure uses a method of using two connected-in-parallel resistors, only needs to control one controllable switch, thus the control method is easy, development difficulty and hardware cost are reduced. The present disclosure should not be limited to use two connected-in-parallel resistors and may use a plurality of resistors connected in parallel. Namely the load unit 40 comprises N resistors connected in parallel, where (N−1) resistors are connected with the controllable switch in series, when the voltage of the cathode of the LED lightbar is greater than or equal to the preset threshold, as long as at least one controllable switch turns on, the resistance value of the load unit can be reduced. Thus, as a number of the controllable switch being on increases, the resistance value of the load unit reduces, where N is a natural number that is greater than or equal to 2.

### EXAMPLE 3

As shown in FIG., the present disclosure provides a method for driving a backlight driving circuit, the backlight driving circuit comprises an LED lightbar, a power supply driving the LED lightbar, and a constant current driving chip controlling the power supply and the LED lightbar. The constant current driving chip comprises a main control unit that drives the power supply, and an adjusting unit that adjusts brightness of the LED lightbar. An input end of the adjusting unit is coupled to a cathode of the LED lightbar, and an output end of the adjusting unit is coupled to a load unit, where a resistance value of the load unit can be adjusted. The method comprises:

A: setting a preset threshold; and

B: monitoring a voltage of the cathode of the LED lightbar, if the voltage of the cathode of the LED lightbar is greater than or equal to the preset threshold, reducing the resistance value of the load unit. If the voltage of the cathode of the LED lightbar is less than the preset threshold, maintaining the resistance value of the load unit.

When the resistance value of the load unit reduces, current flowing through the LED lightbar increases, and brightness of the LED lightbar increases. In order to ensure brightness of the LED lightbar 20 that is short-circuited be consistent with brightness of the LED lightbars that are not short-circuited, the step B comprises: when reducing the resistance value of the load unit, reducing a duty cycle of a driving signal of the adjusting unit, which allows effective current flowing through the LED lightbar 20 that is short-circuited to be consistent with current flowing through the LED lightbars that are not short-circuited.

The controllable switch of the present disclosure uses semiconductor switch device such as a metal-oxide-semiconductor field-effect transistor (MOSFET). The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A backlight driving circuit, comprising:
a light emitting diode (LED) lightbar,
a power supply driving the LED lightbar;
a constant current driving chip controlling the power supply and the LED lightbar; and
a control unit monitoring voltage of a cathode of the LED lightbar;
wherein the constant current driving chip comprises a main control unit that drives the power supply, and an adjusting unit that adjusts brightness of the LED lightbar; an input end of the adjusting unit is coupled to the cathode of the LED lightbar, and an output end of the adjusting unit is coupled to a load unit, a resistance value of the load unit is adjustable;
when the voltage of the cathode of the LED lightbar is greater than or equal to a preset threshold, the control unit controls the load unit to reduce the resistance value of the load unit.

2. The backlight driving circuit of claim 1, wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit;
when the voltage of the cathode of the LED lightbar is greater than or equal to a preset threshold, the first comparator outputs a reserved voltage, and the monitor unit controls the load unit to reduce the resistance value of the load unit; the first reference voltage is less than or equal to the preset threshold.

3. The backlight driving circuit of claim 2, wherein the monitor unit comprises an adjusting assembly that adjusts a duty cycle of a pulse-width modulation (PWM) dimming signal, and the adjusting assembly is coupled to the adjusting unit; when the voltage of the cathode of the LED lightbar is greater than or equal to the preset threshold, the adjusting assembly reduces the duty cycle of the PWM dimming signal.

4. The backlight driving circuit of claim 1, wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

5. The backlight driving circuit of claim 1, wherein the load unit comprises N resistors connected in parallel, and (N−1) resistors are connected with the controllable switches in series; when the voltage of the cathode of the LED lightbar is greater than or equal to the preset threshold, the control unit controls at least one controllable switch to turn on; wherein N is a natural number that is greater than or equal to 2.

6. The backlight driving circuit of claim 5, wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit;
when the voltage of the cathode of the LED lightbars is greater than or equal to the preset threshold, the first comparator outputs a reserved voltage, and the monitor unit controls the load unit to reduce the resistance value of the load unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit; when the voltage of the cathode of the LED lightbar is greater than or equal to the preset threshold, the adjusting assembly reduces the duty cycle of the PWM dimming signal;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

7. The backlight driving circuit of claim 1, the load unit comprises a fist resistor and a second resistor that are connected in parallel; the second resistor is connected with a first controllable switch in series; when the voltage of the cathode of the LED lightbar is greater than or equal to the preset threshold, the control unit controls the first controllable switch to turn on.

8. The backlight driving circuit of claim 7, wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit;
when the voltage of the cathode of the LED lightbar is greater than or equal to the preset threshold, the first comparator outputs a reserved voltage, and the monitor unit controls the load unit to reduce the resistance value of the load unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit; when the voltage of the cathode of the LED lightbar is greater than or equal to the preset threshold, the adjusting assembly reduces the duty cycle of the PWM dimming signal;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

9. The backlight driving circuit of claim 1, wherein the load unit comprises a first resistor and a second resistor that are connected in parallel; the second resistor is connected with a first controllable switch in series;
wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch;
when the voltage of the cathode of the LED lightbar is greater than or equal to the first reference voltage, the first comparator outputs a reserved voltage, the control unit controls the first controllable switch to turn on, and simultaneously, the adjusting assembly reduces the duty cycle of the PWM dimming signal.

10. A light crystal display (LCD) device, comprising:
a backlight driving circuit;
wherein the backlight driving circuit comprises a light emitting diode (LED) lightbar, a power supply driving the LED lightbar, a constant current driving chip controlling the power supply and the LED lightbar, and a control unit monitoring a voltage of a cathode of the LED lightbar;
wherein constant current driving chip includes a main control unit that drives the power supply, and an adjusting unit that adjusts brightness of the LED lightbar; an input end of the adjusting unit is coupled to the cathode of the LED lightbar, and an output end of the adjusting unit is coupled to a load unit, a resistance value of the load unit is adjusted;
when the voltage of the cathode of the LED lightbar is greater than or equal to a preset threshold, the control unit controls the load unit to reduce the resistance value of the load unit.

11. The LCD device of claim 10, wherein the control unit comprises a first comparator and a monitor unit; a first reference voltage is input to a first input end of the first comparator, a second input end of the first comparator is coupled to the cathode of the LED lightbar, and an output end of first comparator is coupled to the monitor unit;
when the voltage of the cathode of the LED lightbar is greater than or equal to the preset threshold, the first comparator outputs a reserved voltage, and the monitor unit controls the load unit to reduce the resistance value of the load unit; the first reference voltage is less than or equal to the preset threshold.

12. The LCD device of claim 10, wherein the monitor unit comprises an adjusting assembly that adjusts a duty cycle of a pulse-width modulation (PWM) dimming signal, and the adjusting assembly is coupled to the adjusting unit; when the voltage of the cathode of the LED lightbar is greater than or equal to the preset threshold, the adjusting assembly reduces the duty cycle of the PWM dimming signal.

13. The LCD device of claim 12, wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

14. The LCD device claim 10, wherein the load unit comprises N resistors connected in parallel, and (N−1) resistors are connected with the controllable switches in series; when the voltage of the cathode of the LED lightbars is greater than or equal to the preset threshold, the control unit controls at least one controllable switch to turn on; wherein N is a natural number that is greater than or equal to 2.

15. The LCD device of claim 14, wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit;
when the voltage of the cathode of the LED lightbar is greater than or equal to the preset threshold, the first comparator outputs a reserved voltage, and the monitor unit controls the load unit to reduce the resistance value of the load unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit; when the voltage of the cathode of the LED lightbar is greater than or equal to the preset threshold, the adjusting assembly reduces the duty cycle of the PWM dimming signal;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

16. The LCD device of claim 10, the load unit comprises a fist resistor and a second resistor that are connected in parallel; the second resistor is connected with a first controllable switch in series; when the voltage of the cathode of the LED lightbar is greater than or equal to the preset threshold, the control unit controls the first controllable switch to turn on.

17. The LCD device of claim 16, wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit;
when the voltage of the cathode of the LED lightbar is greater than or equal to the preset threshold, the first comparator outputs a reserved voltage, and the monitor unit controls the load unit to reduce the resistance value of the load unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit; when the voltage of the cathode of the LED lightbar is greater than or equal to the preset threshold, the adjusting assembly reduces the duty cycle of the PWM dimming signal;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch.

18. The LCD device claim 10, wherein the load unit comprises a first resistor and a second resistor that are connected in parallel; the second resistor is connected with a first controllable switch in series;
wherein the control unit comprises a first comparator and a monitor unit; a first reference voltage is input to a first input end of the first comparator, a second input end of the first comparator is coupled to the cathode of the LED lightbar, and an output end of the first comparator is coupled to the monitor unit; the first reference voltage is less than or equal to the preset threshold;
wherein the monitor unit comprises an adjusting assembly that adjusts a duty cycle of a pulse-width modulation (PWM) dimming signal; and the adjusting assembly is coupled to the adjusting unit;
wherein the adjusting unit comprises a second controllable switch and a second comparator coupled to the second controllable switch; the second controllable switch is connected in series between the cathode of the LED lightbar and the load unit; an output end of the adjusting assembly is coupled to a control end of the second controllable switch;
when the voltage of the cathode of the LED lightbar is greater than or equal to the first reference voltage, the first comparator outputs a reserved voltage, the control unit controls the first controllable switch to turn on, and simultaneously, the adjusting assembly reduces the duty cycle of the PWM dimming signal.

19. A method for driving a backlight driving circuit, the backlight driving circuit comprising a light emitting diode (LED) lightbar, a power supply driving the LED lightbar, and a constant current driving chip controlling the power supply and the LED lightbar; the constant current driving chip comprising a main control unit that drives the power supply, and an adjusting unit that adjusts brightness of the LED lightbar; an input end of the adjusting unit being coupled to a cathode of the LED lightbar, an output end of the adjusting unit being coupled to a load unit, and a resistance value of the load unit being adjusted; the method comprising:
A: setting a preset threshold; and
B: monitoring a voltage of the cathode of the LED lightbar, if the voltage of the cathode of the LED lightbar is greater than or equal to the preset threshold, reducing the resistance value of the load unit; if the voltage of the cathode of the LED lightbar is less than the preset threshold, maintaining the resistance value of the load unit.

20. The method for driving the backlight driving circuit of claim 19, wherein the step B comprises:
when reducing the resistance value of the load unit, reducing a duty cycle of a driving signal of the adjusting unit, which allows effective current flowing through the LED lightbar that is short-circuited to be consistent with current flowing through the LED lightbars that are not short-circuited.
